(19) United States
(12) Patent Application Publication
(10) Pub. No.: US 2010/0021376 A1
(43) Pub. Date: Jan. 28, 2010

(54) CONTROLLED HYDROGEN GENERATION, STORAGE AND TRANSPORTATION SOLUTION

(76) Inventors: Alex Silberman, Haifa (IL); Shmuel Keren, Timrat (IL)

Correspondence Address: Pearl Cohen Zedek Latzer, LLP, 1500 Broadway, 12th Floor, New York, NY, 10036, US

(21) Appl. No.: 12/507,816

(22) Filed: Jul. 23, 2009

Related U.S. Application Data
(60) Provisional application No. 61/082,855, filed on Jul. 23, 2008.

(51) Int. Cl. C01B 3/08; C09K 3/00

(52) U.S. Cl. 423/657; 252/182.32

(57) ABSTRACT

The invention relates to the field of controlled hydrogen generation, hydrogen storage and hydrogen transportation. More specifically, the invention is directed to a solution containing a metal hydride for safe hydrogen generation, storage and transportation, wherein means are provided for preventing spontaneous hydrogen production during storage. In an embodiment of the invention, there is provided a stable metal-hydride solution comprising at least one metal-hydride compound, at least one hydroxide ion providing entity and at least one stabilizer that is different from said hydroxide ion providing entity.

### CROSS-REFERENCE TO RELATED APPLICATIONS

This application claims priority from U.S. Provisional Patent Application No. 61/082,855 filed, Jul. 23, 2009 entitled “Controlled hydrogen generation, storage and transportation solution”, which is incorporated herein by reference in its entirety.

### FIELD OF THE INVENTION

The invention relates to the field of controlled hydrogen generation, hydrogen storage and hydrogen transportation. More specifically, the invention is directed to a solution containing a metal hydride for safe hydrogen generation, storage and transportation, wherein means are provided for preventing spontaneous hydrogen production during storage.

### BACKGROUND OF THE INVENTION

Molecular hydrogen H₂ (referred to herein as hydrogen) is used in many fields, including the petroleum and chemical industries. Hydrogen has wide applications in physics and engineering as well. The production of hydrogen in laboratories is usually performed via the reaction of metals with acids, or by the electrolysis of water. In the industry hydrogen is usually formed by removing hydrogen from hydrocarbons, for example, by reacting natural gas with steam at very high temperatures.

However, all of the above methods require elaborate equipment, and generally cannot be performed efficiently outside the laboratory and/or the production plant.

Furthermore, the generation of hydrogen may be accompanied by the release of energy, which can be exploited for various means. One of the methods for producing hydrogen that generates relatively high amounts of energy, is the oxidation of metal hydrides, producing metal oxides and hydrogen. For example:

BH₄⁻+2H₂O═BO₂⁻+4H₂ (hydrogen evolution).

However, the known methods for hydrogen generation via metal hydride oxidation are shortcoming, especially since the metal hydride tends to spontaneously decompose. The spontaneous decomposition of the metal hydride wastes energy, dangerously increases the pressure within the vessel containing the metal hydride, and generates highly explosive hydrogen gas, which can prove to be hazardous.

Therefore, there is a need for a method by which hydrogen could be generated on-site, in various quantities, and in a controlled manner, i.e., the spontaneous decomposition would be eliminated, thus the hydrogen would be generated only when needed.

### SUMMARY OF THE INVENTION

It is an object of the invention to provide a stable solution comprising a metal hydride, for generating hydrogen in a controlled manner.

It is a further object of the invention to provide a solution comprising a metal hydride that is stable during both storage and transportation.

The invention discloses a stable metal-hydride solution comprising at least one metal-hydride compound, at least one hydroxide ion providing entity and at least one stabilizer that is different from the hydroxide ion providing entity.

The invention discloses also a method for generating hydrogen comprising the step of contacting a catalyst with a stable metal-hydride solution comprising at least one metal-hydride compound, at least one hydroxide ion providing entity and at least one stabilizer, which is different from the hydroxide ion providing entity.

The invention further discloses a device comprising a stable metal-hydride solution comprising at least one metal-hydride compound, at least one hydroxide ion providing entity and at least one stabilizer that is different from the hydroxide ion providing entity.

All the above and other characteristics and advantages of the invention will be further understood through the following illustrative and non-limitative detailed description thereof.

### BRIEF DESCRIPTION OF THE DRAWINGS

The present invention will be understood and appreciated more fully from the detailed description taken in conjunction with the drawings in which:

FIG. 1 shows an example of using the solution of the invention as an energy source in a fuel cell.

FIG. 2 describes a system used for measuring the stability of hydrogen generating solutions, including the solution of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

As mentioned above, the state of the art today is lacking in that the known metal-hydride solutions are prone to spontaneous decomposition, thereby wasting energy, and creating dangerous pressures, as well as highly explosive hydrogen.

The stability of metal-hydride solutions is affected from the temperature and alkalinity of the solution, the amount of catalytic impurities present in the solution (e.g., salts of Ni, Fe, Co, Mg, Ca, etc.), and the stabilizers added to the solution. Generally, an increase of the storage temperature increases the decomposition rate exponentially, and is therefore an obstacle that must be overcome, either by ensuring that the storage temperature remain low, which may prove to be complicated and even impossible when the storage vessel is transferred between various locations, or by stabilizing the solution. As will be detailed herein below, the solution of the invention is stabilized, and therefore, the storage temperature is not a critical factor.

It is known that increasing the alkalinity of the solution is an inexpensive and effective way of increasing the stability of metal hydride containing solutions. However, increasing the alkalinity of the solution to a level that affords the desirable stability for both storage and transportation of the solution usually entails an impractical increase in the solution's viscosity. It should be understood that when the solution is too viscous, the possibilities of pumping it for various uses become difficult, and even impossible. Further, the solubility of various reaction products may decrease with the increase in the viscosity, and the specific energy capacity of the solution tends to drop with the viscosity as well. Moreover, since metal hydrides may decompose on catalyst surfaces, the increase in alkalinity yields a decrease in reactivity. Generally, the optimum hydroxide concentration of metal-hydride solutions is from about 3 to 6 mol/liter. Compliance with storage and transportation regulations, on the other hand, requires a solution stability which is achievable only at hydroxide ion concentrations of at least 8 mol/liter.

The invention discloses a stable metal-hydride solution from which hydrogen can be generated on demand, without spontaneous decomposition, and without encountering the viscosity drawbacks described above. The stable solution of the invention comprises at least one metal hydride compound, at least one hydroxide ion providing entity, and at least one stabilizer that is different from the hydroxide ion providing entity.

According to one embodiment of the invention, when the solution of the invention is stored at room temperature for 0.5 years there is less than 0.2% wt. decomposition of the metal hydride compound. The decomposition was measured using accelerated testing, wherein one week at 70° C. is calculated to be equivalent to 0.5 years at room temperature, according to the Arrhenius Equation. It is noted that the above decomposition percentage includes the experimental error of the method used.

The hydroxide ion providing entity determines the alkalinity, i.e., the high pH, of the solution. According to the invention, the hydroxide ion providing entity is any compound that is capable of providing hydroxide ions in the solution, e.g., by dissociation, decomposition, or by reaction or interaction with any other compound in the solution. In an embodiment of the invention, the hydroxide providing entity, comprises at least one alkali or alkaline earth metal hydroxide and/or ammonium hydroxide. Non-limiting examples of the hydroxide ion providing entity that may be used according to the invention include LiOH, NaOH, KOH, RbOH, CsOH, Ca(OH)₂, Mg(OH)₂, Ba(OH)₂, and NH₄OH. In another embodiment of the invention the hydroxide providing entity may be NaOH, Mg(OH)₂ or KOH.

According to one embodiment of the invention, the concentration of the hydroxide providing entity is between 0.5-14M. According to another embodiment, the concentration of the hydroxide providing entity is between 0.5-5M.

The metal hydride compound used according to the invention includes hydrides, borohydrides and/or aluminum hydrides of alkaline and/or earth alkaline metals. According to one embodiment of the invention, the concentration of the metal hydride compound is at least about 3 mol/liter. Non-limiting examples of the metal hydride compounds that may be used according to the invention are NaBH₄, KBH₄, LiBH₄, Be(BH4)₂, Ca(BH₄)₂, Mg(BH₄)₂, (CH₃)₃NHBH₃, NaCNBH₃, LiH, NaH, KH, CaH₂, BeH₂, MgH₂, NaAlH, LiAlH₄, and KAlH₄. In an embodiment of the invention the metal hydride compounds are at least one of NaBH₄, KBH4, LiBH₄, LiH, NaH, and KH. In another embodiment the metal hydride compounds may be NaBH₄ and/or KBH₄. When the metal hydride compound is oxidized, it produces hydrogen, as can be seen from the non limiting example below:

[Metal]BH₄+2H₂O [symbol] [Metal]BO₂+4H₂.

As mentioned above, the solution of the invention provides hydrogen in a controlled manner, i.e., the metal hydride is not oxidized until necessary. This feature requires the solution to be stabilized. In addition to the alkalinity of the solution, at least one stabilizer, that is not a hydroxide ion providing entity, is added to the solution of the invention in order to prevent spontaneous oxidation/decomposition of the metal hydride in the solution.

The stabilizers used according to the invention are nitrogen heterochain and/or heterocyclic compounds comprising the —N—C═N— moiety, wherein the imine nitrogen may be either quaternary or not. Thus, the stabilizers used according to the invention include molecules of the following forms:

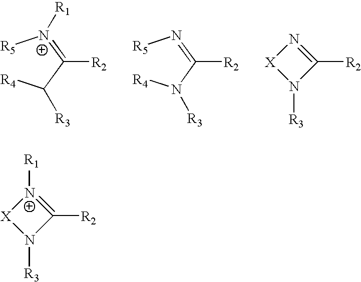

wherein R₁ is an aliphatic or aromatic radical; R₂, R₃, R₄, R₅ are each independently H, aliphatic or aromatic radical, halogen, carboxyl, amine, hydroxyl, or an X-chain moiety containing two or more atoms that are C, N, O or S, wherein the X-chain is either substituted or not, and is linked to the molecule by a single, double, or triple bond.

Specific, non-limiting, examples of the stabilizer used according to the invention are 1,2-dimethyl-1H-imidazole-4-sulfonyl chloride, 1,3-Bis(2,4,6-trimethylphenyl)imidazolinium chloride, 4-(3-butoxy-4-methoxybenzyl)imidazolin-2-one, and diethyl imidazole bromide.

According to one embodiment of the invention, the concentration of the stabilizer is 0.1-50 mmol/liter. In another embodiment of the invention, the concentration of the stabilizer is 0.1-10 mmol/liter. In another embodiment of the invention, the concentration of the stabilizer is 10-20 mmol/liter. In another embodiment of the invention, the concentration of the stabilizer is 20-30 mmol/liter. In another embodiment of the invention, the concentration of the stabilizer is 30-40 mmol/liter. In another embodiment of the invention, the concentration of the stabilizer is 40-50 mmol/liter. The concentration of the stabilizer depends on the specific stabilizer used, the concentrations of the other entities in the solution, and the required balance between the stability and the reactivity of the solution.

In one embodiment of the invention, the solution may further comprise at least one plasticizer and/or at least one detergent and/or at least one polar solvent. The polar solvent that may be used according to the invention is water, an aliphatic alcohol having up to about 6 carbon atoms and up to about 4 hydroxy groups, a C₂₋₄ alkylene glycol, a di(C₂₋₄ alkylene) glycol, a mono-C₁₋₄-alkyl ether of a C₂₋₄ alkylene glycol or di(C₂₋₄ alkylene) glycol, a di-C₁₋₄-alkyl ether of a C₂₋₄ alkylene glycol or di(C₂₋₄ alkylene) glycol, an aliphatic ether having up to about 6 carbon atoms, an aliphatic ketone having up to about 6 carbon atoms, and/or a C₁₋₃ alkyl ester of a C₁₋₃ alkanoic acid.

Non-limiting examples of polar solvents that may be used according to the invention include methanol, ethanol, ethylene glycol, glycerol, ethyl acetate, diethylene glycol, acetone, methyl ethyl ketone, methyl acetate, dioxin, tetrahydrofiran, diethyl ketone, diglyme (2-methoxyethyl ether), and triglyme (triethylene glycol dimethyl ether).

According to one embodiment of the invention, the polar solvent is added in an amount of about 15% of the solution.

When there is a desire to produce hydrogen from the solution of the invention, the stable solution described above is contacted with a catalyst. Any type of appropriate catalyst can be used according to the invention, including platinum (Pt), palladium (Pd), rhodium (Rh), ruthenium (Ru) as well as Pt/Pd alloys, Rd/Ru alloys and Pt/Ru alloys.

In an embodiment of the invention the present invention also is directed to a method of producing hydrogen, wherein a solution comprising at least one metal hydride compound, at least one hydroxide ion providing entity, and at least one stabilizer, which is different from the hydroxide ion providing entity, as defined hereinabove, is contacted with an appropriate catalyst. The catalyst used according to the invention is any appropriate catalyst known in the art.

The solution of the invention may be used in any instance that requires a supply of hydrogen and may be placed in any appropriate device. In addition, due to the high specific energy content of the solution of the invention, it may further be used in an instance where the supply of energy is required. Further, due to the stability of the solution of the invention it may be stored for long lengths of time. Moreover, the solution of the invention may be transported from place to place with no danger of spontaneous decomposition, and therefore is appropriate for use both in mobile and in non-mobile devices.

Devices containing the solution of the invention may comprise means by which the contact between the solution and the catalyst is regulated, thereby producing hydrogen in accordance with the requirements in each instance.

Non-limiting examples of devices that may utilize the solution of the invention are fuel cells including ones for automotive applications, backup systems for e.g., network servers (including cell phone networks), portable backup systems for e.g., laptop, PDA's computers and cellular phone systems, etc.

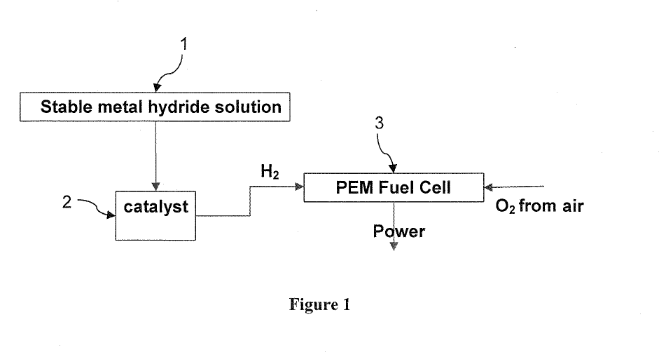

FIG. 1 is a non-limiting example of using the solution of the invention as fuel for a polymer electrolyte membrane (PEM) fuel cell. The solution of the invention is stored in a solution chamber (1), and the catalyst is stored in a catalyst chamber (2). When the solution in chamber (1) and the catalyst in chamber (2) are contacted, H₂ is produced. The produced H₂ enters the PEM fuel cell (3), where it is oxidized on the anode (not shown in the figure), while the oxidant (O₂) is reduced on the cathode (not shown in the figure), thereby yielding water and electricity. Since the solution of the invention, stored in the described fuel cell is a stable solution, the fuel cell can be stored over long periods of time, before use. Further, the described fuel cell can be transported without danger.

The advantages of the solution of the invention are as follows: first, the solution is stable, and therefore no free hydrogen is produced when undesired. This enables the solution to be stored for long lengths of time, and to further be transported from place to place with no danger of explosion etc. Further, the energy density of the solution of the invention is extremely high, thus even small quantities of the solution of the invention can be used to produce large quantities of energy. Finally, no heavy metals or toxic additives are used according to the invention, and therefore it is environmentally friendly.

It will be appreciated by persons skilled in the art that the present invention is not limited by what has been particularly shown and described herein above. Instead, the scope of the present invention includes both combinations and subcombinations of the various features described hereinabove as well as variations and modifications which would occur to persons skilled in the art upon reading the specifications and which are not in the prior art.

The invention will be further illustrated with reference to the following illustrative examples, which are not intended to limit the scope of the invention in any manner,

### Examples

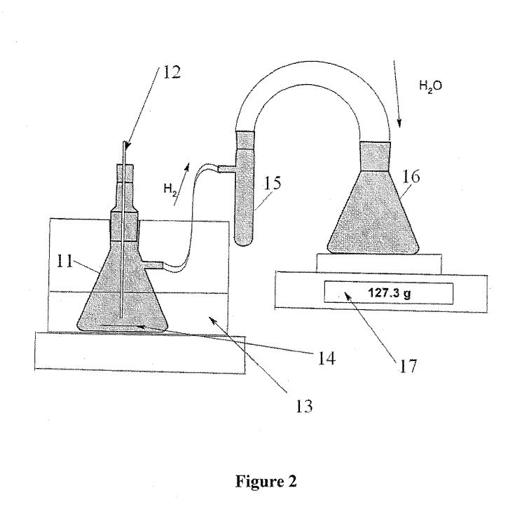

FIG. 2 describes a system assembled in order to measure the stability of hydrogen generating solutions, including the solution of the invention, as detailed below. Various solutions were placed in flask (11), where the temperature was continually measured by thermocouple (12). The temperature of the solutions was determined according to heater (13), and the solutions were continuously stirred by stirrer (14). When hydrogen is produced, it exits flask (11), through trap (15) to flask (16), which contains water. When the hydrogen enters flask (16), it replaces water found therein, thereby changing the weight of flask (16). The weight of flask (16) is constantly measured by scale (17), allowing the user to determine the weight of water displaced by the produced hydrogen thereby allowing the calculation of the amount of hydrogen produced, indicating the stability of the solution of the invention.

### Example 1

### Influence of Alkalinity on Hydrogen Generation

The following procedure was followed in order to access the influence of the alkalinity on the stability of a prior art solution, which does not contain the stabilizers according to the invention.

100 ml of 4M NaBH₄ and 2M KOH were placed in flask (11) and were heated by heater (13) to 70° C., the temperature being measured by thermocouple (12). The results of the experiment showed that the hydrogen evolution rate after 1-1.5 hours was 6.56 ml/minutes at 70° C. 100 ml of a second solution comprising 4M NaBH₄ and 6M KOH was placed in flask (11) and were heated by heater (13) to 70° C., the temperature being measured by thermocouple (12). The results, also measured after 1-1.5 hours, showed that the increase of the concentration of the KOH to 6M decreased the hydrogen evolution rate to 0.2 ml/min. Thus, a three fold increase in the alkalinity of the solution resulted in an almost 33 fold decrease in the hydrogen evolution rate.

It is noted that approximately the same results were obtained when using other hydride and borohydride solutions.

### Example 2

### Influence of Stabilizers on Hydrogen Generation

The stability of five different solutions was tested at two different temperatures. Each of the solutions contained 4M NaBH₄ and 1M KOH. The first solution was a control, i.e., no stabilizer was added, and each of the remaining four solutions contained 5 mM of a specific stabilizer, as detailed below. Table I below shows the hydrogen evolution rate in ml/min for each solution, wherein the solutions were allowed to sit for 10-25 minutes before measurements were taken.

TABLE I

| | | Stabilizer | | Stabilizer | Stabilizer |
|---|---|---|---|---|---|
| | | 1 | Stabilizer 2 | 3 | 4 |
| Temperature | Control | 5 mM | 5 mM | 5 mM | 5 mM |
| 25° C. | 0.3 | Not | Not detected | Not | 0.1 |
| | | detected | | detected | |
| 50° C. | 9.4 | 2.3 | Not detected | 1.5 | 3.5 |

The stabilizers added to the solutions above are: 1,2-dimethyl-1H-imidazole-4-sulfonyl chloride (Stabilizer 1), 1,3-Bis(2,4,6-trimethylphenyl)imidazolinium chloride (Stabilizer 2), 4-(3-Butoxy-4-methoxybenzyl)imidazolidin-2-one (Stabilizer 3), and diethyl imidazole bromide (Stabilizer 4).

As apparent from the results detailed in Table I, the addition of any of the above stabilizers renders the solution of the invention more stable than the control solution, i.e., the addition of stabilizers according to the invention lowers the hydrogen evolution rate. This stabilization is extremely surprising, especially due to the low alkalinity of the solutions.

As the temperature rises, the stability of the solutions is decreased. This decrease in stability is most prominent in the control solution. Further, as shown in Table I, the most advantageous stabilizer used in the above experiments is Stabilizer 2, where even at 50° C. no hydrogen evolution is detected.

### Example 3

### Influence of Stabilizer 2 on Hydrogen Generation

### Control Solution (No Stabilizer)

22.4 gr of KOH (Frutarom Ltd.) were dissolved in 80 ml of dionized water (DI water) and cooled to room temperature. 15.12 gr NaBH₄ were added to the KOH solution, while stirring for about 30 minutes. DI water was added to the solution to result in a final volume of 100 ml, wherein the concentrations of the components were 4M NaBH₄ and 4M KOH.

The above solution was placed in flask (11), which was heated by heater (13) to 70° C., measured by thermocouple (12). The temperature of the solution was kept at 70° C. for 10 minutes in order to obtain thermostatic conditions. The results of the experiment showed a hydrogen evolution rate of 1.42 ml/minutes.

Solution with 3-Bis(2,4,6-trimethylphenyl)imidazolinium chloride (Stabilizer 2)

11.2 gr of KOH (Frutarom Ltd.) were dissolved in 80ml of dionized water (DI water) and cooled to room temperature. 15.12 gr NaBH₄ were added to the KOH solution, while stirring for about 30 min. DI water was added to the solution to result in a final volume of 100 ml, wherein the concentrations of the components were 2M KOH and 4M NaBH₄. 0.17 gr of 1,3-Bis(2,4,6-trimethylphenyl)imidazolinium chloride (Stabilizer 2) were added to the above solution while stirring. The solution was placed in flask (11) and was heated by heater (13) to 70° C., the temperature being measured by thermocouple (12). The temperature of the solution was kept at 70° C. for 10 min in order to obtain thermostatic conditions. The results of the experiment showed that the hydrogen evolution rate was less than 0.01 ml/min.

A seen from the comparison between the control solution and the solution comprising Stabilizer 2, the stabilizer substantially increases the stability of the solutions of the invention. It should be noted that even though the alkalinity of the control solution is two fold that of the solution comprising Stabilizer 2, the stability of the solution comprising Stabilizer 2 is about 142 times greater than that of the control solution.

Although embodiments of the invention have been described by way of illustration, it will be understood that the invention may be carried out with many variations, modification, and adaptations, without departing from its spirit or exceeding the scope of the claims.

1. A stable metal-hydride solution comprising at least one metal-hydride compound, at least one hydroxide ion providing entity and at least one stabilizer that is different from said hydroxide ion providing entity.

2. The stable metal-hydride solution according to claim 1, wherein less than 0.2% wt of the metal hydride compound decomposes when said solution is stored at room temperature for 0.5 years.

3. The stable metal-hydride solution according to claim 1, wherein the hydroxide ion providing entity comprises at least one alkali or alkaline earth metal hydroxide, or ammonium hydroxide.

4. The stable metal-hydride solution according to claim 1, wherein the hydroxide ion providing entity is LiOH, NaOH, KOH, RbOH, CsOH, Ca(OH)₂, Mg(OH)₂, Ba(OH)₂ or NH₄OH.

5. The stable metal-hydride solution according to claim 1, wherein the metal hydride compound is a hydride, borohydride or aluminum hydride of an alkaline or earth alkaline metal.

6. The stable metal-hydride solution according to claim 1, wherein the metal hydride compound is NaBH₄, KBH₄, LiBH₄, Be(BH4)₂, Ca(BH₄)₂, Mg(BH₄)₂, (CH₃)₃NHBH₃, NaCNBH₃, LiH, NaH, KH, CaH₂, BeH₂, MgH₂, NaAlH, LiAlH₄, or KAlH₄.

7. The stable metal-hydride solution according to claim 1, wherein the stabilizer is a nitrogen heterochain or heterocyclic compound comprising the —N—C═N— moiety.

8. The stable metal-hydride solution according to claim 1, wherein the stabilizer is any compound according to the formulae set forth below: 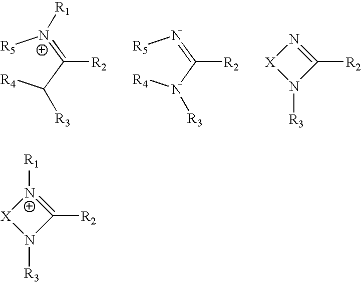
wherein R₁ is an aliphatic or aromatic radical; R₂, R₃, R₄, R₅ are each independently H, an aliphatic or aromatic radical, halogen, carboxyl, amine, hydroxyl, and an X-chain moiety containing two or more atoms that are C, N, O or S, wherein the X-chain is either substituted or not, and is linked to the molecule by a single, double, or triple bond.

9. The stable metal-hydride solution according to claim 1, wherein the stabilizer is 1,2-dimethyl-1H-imidazole-4-sulfonyl chloride, 1,3-Bis(2,4,6-trimethylphenyl)imidazolinium chloride, 4-(3-butoxy-4-methoxybenzyl)imidazolin-2-one, or diethyl imidazole bromide.

10. The stable metal-hydride solution according to claim 1, wherein the stabilizer is in an amount of about 0.5-50 mmol/liter.

11. The stable metal-hydride solution according to claim 1, wherein the solution further comprises at least one plasticizer, at least one detergent, at least one polar solvent, or any combination thereof.

12. The stable metal-hydride solution according to claim 11, wherein the polar solvent is water, an aliphatic alcohol having up to about 6 carbon atoms and up to about 4 hydroxy groups, a C₂₋₄ alkylene glycol, a di(C₂₋₄ alkylene) glycol, a mono-C₁₋₄-alkyl ether of a C₂₋₄ alkylene glycol or di(C₂₋₄ alkylene) glycol, a di-C₁₋₄-alkyl ether of a C₂₋₄ alkylene glycol or di(C₂₋₄ alkylene) glycol, an aliphatic ether having up to about 6 carbon atoms, an aliphatic ketone having up to about 6 carbon atoms or a C₁₋₃ alkyl ester of a C₁₋₃ alkanoic acid.

13. A method for generating hydrogen comprising the step of contacting a catalyst with a stable metal-hydride solution comprising at least one metal-hydride compound, at least one hydroxide ion providing entity and at least one stabilizer, which is different from said hydroxide ion providing entity.

14. The method according to claim 13, wherein the stabilizer is a nitrogen heterochain or heterocyclic compound comprising the —N—C═N— moiety.

15. The method according to claim 13, wherein the stabilizer is 1,2-dimethyl-1H-imidazole-4-sulfonyl chloride, 1,3 -Bis(2,4,6-trimethylphenyl)imidazolinium chloride, 4-(3-butoxy-4-methoxybenzyl)imidazolin-2-one, or diethyl imidazole bromide.

16. A device comprising a stable metal-hydride solution comprising at least one metal-hydride compound, at least one hydroxide ion providing entity and at least one stabilizer that is different from said hydroxide ion providing entity.

17. The device according to claim 16, further comprising a catalyst.

18. The device according to claim 17 comprising means by which the contact between the stable metal-hydride solution and the catalyst is regulated.

19. The device according to claim 16, wherein the stabilizer is a nitrogen heterochain or heterocyclic compound comprising the —N—C═N— moiety.

20. The device according to claim 16, wherein the stabilizer is 1,2-dimethyl-1H-imidazole-4-sulfonyl chloride, 1,3-Bis(2,4,6-trimethylphenyl)imidazolinium chloride, 4-(3 -butoxy-4-methoxybenzyl)imidazolin-2-one, or diethyl imidazole bromide.
